(19) United States
(12) Patent Application Publication
(10) Pub. No.: US 2023/0062028 A1
(43) Pub. Date: Mar. 2, 2023

(54) DIGITAL TWIN SIMULATION OF EQUILIBRIUM STATE

(71) Applicant: KYNDRYL, INC., New York, NY (US)

(72) Inventors: Sarbajit K. Rakshit, Kolkata (IN); Pritpal S. Arora, Bangalore (IN); Laxmikantha Sai Nanduru, Secunderabad (IN)

(21) Appl. No.: 17/412,649

(22) Filed: Aug. 26, 2021

(51) Int. Cl. G06F 30/20; G06T 19/00; G16Y 20/20; G16Y 20/10

(52) U.S. Cl. CPC G06F 30/20; G06T 19/006; G16Y 20/20; G16Y 20/10

(57) ABSTRACT

A processor may receive object data associated with a position and an orientation of a first object in an environment from IoT sensors. The processor may generate a digital twin simulation of the first object. In some embodiments, the digital twin simulation may include data associated with the relative positions and orientations of one or more other objects to the first object. The processor may calculate forces acting on the first object. The processor may identify whether the first object is in a state of instability.

### BACKGROUND

The present disclosure relates generally to the field of digital twins, and more specifically to determining whether an object is in a state of disequilibrium/instability using a digital twin simulation in order to prevent accidents.

A digital twin is a virtual model designed to accurately reflect a physical object and simulates the virtual environment of the physical object.

### SUMMARY

Embodiments of the present disclosure include a method, computer program product, and system for determining whether an object is in a state of disequilibrium/instability using a digital twin simulation in order to prevent accidents. A processor may receive object data associated with a position and an orientation of a first object in an environment from IoT sensors. The processor may generate a digital twin simulation of the first object. In some embodiments, the digital twin simulation may include data associated with the relative positions and orientations of one or more other objects to the first object. The processor may calculate forces acting on the first object. The processor may identify whether the first object is in a state of instability.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for determining an instability state of an object, in accordance with aspects of the present disclosure.

FIG. 2 is a flowchart of an exemplary method system for determining an instability state of an object, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of digital twins, and more specifically to determining whether an object is in a state of disequilibrium/instability using a digital twin simulation in order to prevent accidents. While the present disclosure is not necessarily limited to such applications, various aspects of the disclosure may be appreciated through a discussion of various examples using this context.

In some embodiments, a processor may receive object data associated with a position and an orientation of an object in an environment from internet of things (“IoT”) sensors. In some embodiments, the IoT sensors may include cameras, thermal sensors, ultrasound sensors, etc. In some embodiments, image analytics may be performed on the images obtained from the camera feeds to identify the first object, its position, and its orientation. For example, based on image data from cameras located in a warehouse a package may be identified among other packages in a stack of packages in the warehouse. The position of the package (e.g., coordinates in three dimensional space) as well as the orientation of the packages may also be detected from the camera data feed. In some embodiments, the IoT sensors may detect the positions and/or orientations of other objects relative to the first object (e.g., which dimensions of the first objects are adjacent to which dimensions of the other objects). In some embodiments, other characteristics of the first object and the other object(s) may be determined, including weight, shape, dimensions, type of contents (e.g., fluids or dense materials, sensitive equipment, cold objects, sharp objects, etc.), etc. In some embodiments, the other characteristics may be detected by IoT sensors or determined by other means. As an example, data regarding other characteristics of the first object may be obtained from bar codes on the object (e.g., providing information about the weight of the object or materials making up the object). In some embodiments, secondary validation of (or improvements in the confidence of the data regarding) the position and orientation of the first object may be provided by various camera and/or other sensors.

In some embodiments the processor may generate a digital twin simulation of the first object in the environment. In some embodiments, the digital twin simulation may include data associated with the relative positions and orientations of one or more other objects to the first object in the environment. In some embodiments, the digital twin simulation may include a replica of the environment and any furnishing/fixtures in the environment. For example, the digital twin simulation may replicate the dimension of the warehouse, dimensions and locations of any enclosures, dimensions and locations of any open spaces (e.g., passageways), location and dimensions of shelves or storage bins, etc. In some embodiments, the digital twin simulation may replicate how the first object is placed in the environment with respect to the other objects in the environment (e.g., stacked on top of each other, in a particular order, with surfaces of a particular dimension in contact with one another, etc.). In some embodiments, the relative positions and orientations of one or more other objects in the environment may include the distance between the first object and the other objects, the alignment of the other objects relative to the first object (e.g., comparing the alignment of a particular dimension of the objects), the relative positions (e.g., above, below, to the side, etc.) of the other objects to the object, etc. The relative positions and orientations of one or more other objects in the environment may include data regarding the position, orientation, or stacking order of the objects.

In some embodiments the processor may determine forces acting on the first object. In some embodiments, the forces may include gravity, forces from the other objects (e.g., other objects stacked on top of the object, electromagnetic forces, electric forces, chemical forces, etc.), forces from containers/enclosures/furnishings in, on, or in proximity to which the first object is placed (e.g., flammable contents, electrical wiring, etc.), etc. In some embodiments, the forces may include external force created by movement/handling of the object (e.g., by a person or using a tool such as a forklift) or other environmental conditions (e.g., wind flow, magnetic force, etc.). In some embodiments, the forces may be determined using strain gauge reading to detect (and then simulate) indeterminate force vectors. In some embodiments, the forces may be calculated based on information regarding physical characteristics of the first object or the other objects obtained from the first object data.

In some embodiments, the processor may determine/identify whether the first object is in a state of instability. In some embodiments, a state of instability/disequilibrium may exist if the object, as it is positioned and oriented, is likely to move based on the forces acting on it. In some embodiments, the digital twin simulation may simulate the forces acting on the first object and determine the likelihood of the first object moving at a future time due to the forces acting on it. In some embodiments, the likelihood of future movement of the first object may be determined utilizing a stability theorem.

For example, a first package may be placed on a stack of packages, and then three new packages may be placed on top of the first package. If the first package was not placed on the stack with the correct orientation (e.g., the first package was not aligned properly in the stack of packages), the percentage deviation from an acceptable orientation or a range of acceptable orientations may be determined from the object data. In some embodiments, the digital twin simulation may replicate how the first package is placed on the stack and the forces acting on the first packages from the three new packages. In some embodiments, the digital twin simulation may predict that the forces acting on the improperly aligned first package are too high (e.g., simulated vectors associated with placement of the packages indicate, based on a threshold, that the packages are likely to tilt and fall in a particular direction, thus indicating to a user that an accident is likely to occur if not action is taken), and that the first package is in a state of instability (e.g., may move from its position in the stack because of the forces acting on it). In some embodiments, the digital twin simulation may also predict the level of external force needed to alter the stability and equilibrium of the first package.

In some embodiments, based on the identifying/determining that the first object is in the state of instability, a user may be alerted/notified of the state of instability and/or a predicted outcome/accident (e.g., the packages will fall to the left, the extension cord in a particular area could be a tripping hazard). Following the example above, once it is predicted that the forces acting on the improperly aligned first package are too high, the user utilizing the digital twin simulation may have a pop-up notification displayed to them that indicates that the stack of packages should be rearranged to avoid them falling.

In some embodiments, the state of disequilibrium/instability may be based on properties of the objects and a determining of the objects are incompatible (e.g., due to chemical incompatibility, likely combustibility, etc. For example, two mutually inflammable objects (chemicals) placed next to be each other in a storage site by oversight may be identified by the disclosed system and the likely instability of the objects may be alerted/notified to a user to avoid any incidences with the objects. As another example, inflammable materials placed closed to where electrical wiring is running that may lead to a major disaster when human or robotic mishandling (e.g., human/robotic forces) occur may be identified based on the instability of the materials next to the wiring. The disclosed solution/system provided herein may capture a large amount of data from warehouses and use digital simulations to detect such mistakes if they occur and avert accidents.

In some embodiments, the processor may be able to determine whether two or more objects are in a state of instability. In some embodiments, the processor may be able to compare the likelihood of movement of one object to the likelihood of another object. In some embodiments, the processor may receive second object data associated with a position and an orientation of a second object in an environment from the IoT sensors. In some embodiments, the processor may generate a second digital twin simulation based on the second object. In some embodiments, the second digital twin simulation may include data associated with relative positions and orientations of one or more other objects to the second object. In some embodiments, the processor may determine forces acting on the second object. In some embodiments, the processor may rank an instability score associated with the first object relative to an instability score associated with the second object. In some embodiments, the instability scores may reflect the likelihood of the objects to move, and the ranking may reflect the urgency/priority associated with the higher ranked object. For example, a first object may be in a stack that is heavily unbalanced with excessive weight stacked at the top of the stack above the first object. The second object may be positioned on a stack of objects in a manner where that forces from other objects are presented/pushing on a side of the second object with less surface area. The first object may have a higher instability score, indicating that it is more likely to move/be unstable/cause its stack to topple, than the second object.

In some embodiments the processor may predict a likelihood of an incident associated with the state of instability of the first object. Continuing the example of the first package that was placed with improper alignment on a stack of packages with three new packages placed on top of it on the stack, the digital twin simulation may predict that the forces acting on the improperly aligned first package may cause the package to move, apply forces to other packages in the stack, and cause the stack of packages to fall down. The digital twin simulation may predict the likelihood based on conditions ascertained from the object data. For example, the greater the weight of the three new packages, the greater the likelihood of the stack falling down.

In some embodiments, the incidents, about which the processor may make predictions, may be identified and classified from historical information about observed incidents (e.g., object data from IoT sensors) or historical information from various simulations run in the digital twin environment. In some embodiments, the incidents may include classes or categories of outcomes resulting from the future locations and positions of the first object, a state of instability of the first object, a scoring of the instability of the first object, the physical effect of the movement of the first object on nearby or distant other objects, the future positions and orientations of the other objects, etc. In some embodiments, the predictions may be made using algorithms relating to the effect of the instability of one object on the instability of other objects in its vicinity or contact.

In some embodiments, the incidents may relate to the likelihood that the objects or materials of the objects may be damages (e.g., due to an accident or an occurrence that damages the objects). In some embodiments, the likelihood of an incident involving multiple objects may be determined using regression modeling. In some embodiments, regression modeling may involve applying multinomial logarithmic regression models to obtain a predicted equilibrium f(E) from multiple features, including positions, orientations, stacking orders, weights, forces, etc. In some embodiments, regression modeling may involve applying probit logarithmic regression models to obtain accident probabilities. For example, if response variable Y is binary, it can have only two possible outcomes denoted as 1 and 0 for accident probabilities. Y may represent the presence/absence of a certain condition, an accident involving some object due to multiple factors as a vector of regressors X (multi-variate readings of positions, orientations, stacking orders, weights, forces, etc.), which are assumed to influence the outcome Y. In some embodiments, the probability may be represented as Pr(Y=1 X)=Φ(Xβ), where Φ is the cumulative distribution function of the standard normal distribution and the parameters β are typically estimated by maximum likelihood. In some embodiments, multinomial logarithmic regression models may be applied to obtain re-calibrated positions R(X,Y,Z) from multi-variate features (e.g., determining a likely future position). In some embodiments, the predictor function for the new re-calibrated orientations may be computed as f(k,i)=βk*xi, where βk is the set of regression coefficients associated with outcome k, and xi (a row vector) is the set of explanatory variables of positions, orientations, stacking orders, weights, forces, etc. associated with observation i.

In some embodiments the processor may recommend an alternative position or an alternative orientation of the first object using an augmented reality interface. In some embodiments, the augmented reality interface may be on a computer screen visible to people that are employed in the warehouse. Continuing the previous example, the augmented reality interface may show that the first package was misaligned by providing an overlay over an image of the object that shows the preferred position and preferred orientation of the object. (e.g., the length of the package should be parallel to the length of the lower-stacked package, allowing only a 5% deviation from parallel). In some embodiments, a recommendation regarding an alternative position and/or an alternative orientation may be provided to the user auditorily via a voice assistance program.

In some embodiments the processor may identify the alternative position or the alternative orientation of the first object. In some embodiments, the alternative position or alternative orientation may be obtained from a database of alternative positions and/or orientation or historical information. In some embodiments the processor may generate an alternative digital twin simulation of the first object. In some embodiments, the digital twin simulation may include data associated with the relative positions and orientations of one or more other objects to the first object having the alternative position or the alternative orientation. In some embodiments, the processor may calculate forces acting on the first object having the alternative position or the alternative orientation. In some embodiments, the forces do not result in a state of instability for the first object.

In some embodiments the processor may monitor the position of a user within the environment. In some embodiments the processor may predict one or more future positions of the user within the environment. In some embodiments the processor may predict a change to the state of instability of the first object based on the one or more future positions of the user. For example, the IoT sensors may detect that a user is moving towards a stack of goods. The user may be moving along the aisles having the stack of goods at an angle, rather than a straight line, which may result in the user making contact with the some goods in the stack of goods. Based on the predicted future position of the user, the processor may predict that one or more of the objects in the stack may become unstable and move from their positions.

In some embodiments, the processor may infer the movement of a user and activities of a user as external stimuli, and based on historical analysis of similar activities and event correlations, the processor may predict the magnitude, direction and duration of force that may be caused by such activities. In some embodiments, the digital twin simulation may be used to identify if there will be any instability caused by such activities and the magnitude of the instability which may cause an accident. In some embodiments, the processor may track human movements and object handling in the surrounding using wearable devices and movement sensors. In some embodiments, the processor may identify the profile of the user and the activity the user is performing. In some embodiments, based on the analysis of the activities in the surrounding, the digital twin simulation may identify the force distribution, including that of gravitational force and the external forces that may be applied through human handling and movements.

In some embodiments, the processor may identify one or more alternative positions of the user. In some embodiments, the processor may generate an alternative digital twin simulation based on the one or more alternative positions of the user. In some embodiments, the alternative digital twin simulation may include data associated with the one or more alternative positions of the user relative to the first object. In some embodiments, the processor may calculate alternative forces acting on the first object, wherein the alternative forces do not result in a state of instability for the first object. Continuing the previous example, the one or more alternative positions may direct the user to move in a straight line that will not cause the user to apply a force (directly or indirectly) onto the first object and not result in a state of instability for the first object.

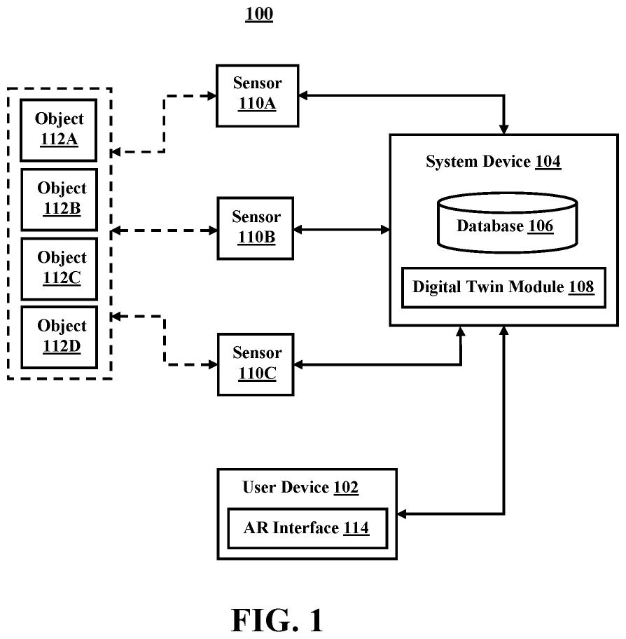

Referring now to FIG. 1, a block diagram of a system 100 for determining an instability state of an object is illustrated. System 100 includes a user device 102 and a system device 104. The user device 102 is configured to be in communication with the system device 104. The system device 104 includes a database 106 and a digital twin module 108. In some embodiments, the user device 102 and the system device 104 may be any devices that contain a processor configured to perform one or more of the functions or steps described in this disclosure.

In some embodiments, sensors 110A-C obtain sensor data associated with the position and orientation of a first object 112A in the environment. The object data is sent to system device 104, stored in database 106, and used by the digital twin module 108 to generate a digital twin simulation of the first object 112A. The digital twin simulation replicates the positions and orientations of other objects (objects 112B-D) relative to the first object 112A. In some embodiments, the orientations of the other objects are identified/determined by any combination of the sensors 110A-C. In some embodiments, the system device 104 calculates the forces acting or likely/predictive forces (e.g., human, robotic, external, chemical, electrical, etc.) to act on the first object 112A. The system device 104 identified whether the first object 112A is in a state of instability (e.g., is an object likely to fall off a shelf, is a hose in the pathway of a common walking area, etc.).

In some embodiments, sensors 110A-C obtain sensor data associated with the position and orientation of a second object in the environment, object 112B. The object data is used by the digital twin module 108 to generate a digital twin simulation of the second object 112B. The digital twin simulation replicates the positions and orientations of other objects (objects 112A, 112C-D) relative to the second object 112B. In some embodiments, the system device 104 calculates the forces acting or likely/predictive forces to act on the second object 112B. In some embodiments, the system device 104 ranks an instability score associated with the first object 112A relative to an instability score associated with the second object 112B (e.g., if the first object is a compound that reacts with water and the second object is a water fountain, the instability scores could be elevated relative to one another to avoid an likely accident between/with the objects; if the first object and the second object are inert to one another, the instability scores could be lowered as no accident is likely to occur).

In some embodiments, the system device 104 may communicate a recommendation for a preferred position and preferred orientation of the first object 112A to the user device 102 (e.g., the first object should be moved to another location to avoid an accident). In some embodiments, the preferred position and preferred orientation are displayed to a user on the augmented reality interface 114 of the user device 102.

In some embodiments, sensors 110A-C may be used to monitor a position of a user within the environment. Sensor data may be sent to the system device 104, and the digital twin module 108 may predict one or more future positions of the user within the environment. Based on the predicted future position of the user, the digital twin module 108 may predict a change to the state of instability of an object (e.g., 112A) to avoid an accident (e.g., if a user is likely to walk through an area, it may indicate that the object should be moved to avoid a collision).

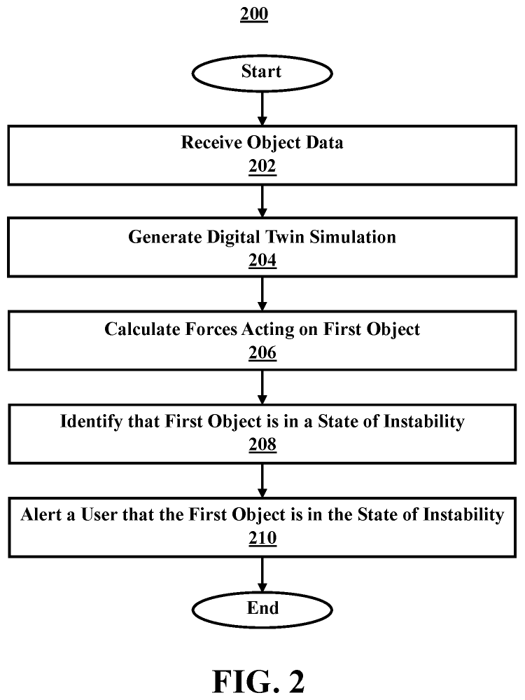

Referring now to FIG. 2, illustrated is a flowchart of an exemplary method 200 for determining an instability state of an object, in accordance with embodiments of the present disclosure. In some embodiments, a processor of a system may perform the operations of the method 200. In some embodiments, method 200 begins at operation 202. At operation 202, the processor receives object data associated with a position and an orientation of a first object in an environment from IoT sensors. In some embodiments, method 200 proceeds to operation 204, where the processor generates a digital twin simulation of the first object. In some embodiments, the digital twin simulation includes data associated with the relative positions and orientations of one or more other objects to the first object.

In some embodiments, method 200 proceeds to operation 206. At operation 206, the processor calculates forces acting on the first object. In some embodiments, method 200 proceeds to operation 208. At operation 208, the processor identifies whether the first object is in a state of instability. In some embodiments, method 200 proceeds to operation 210, where the processor alerts/notifies a user that the first object is in a state of instability.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

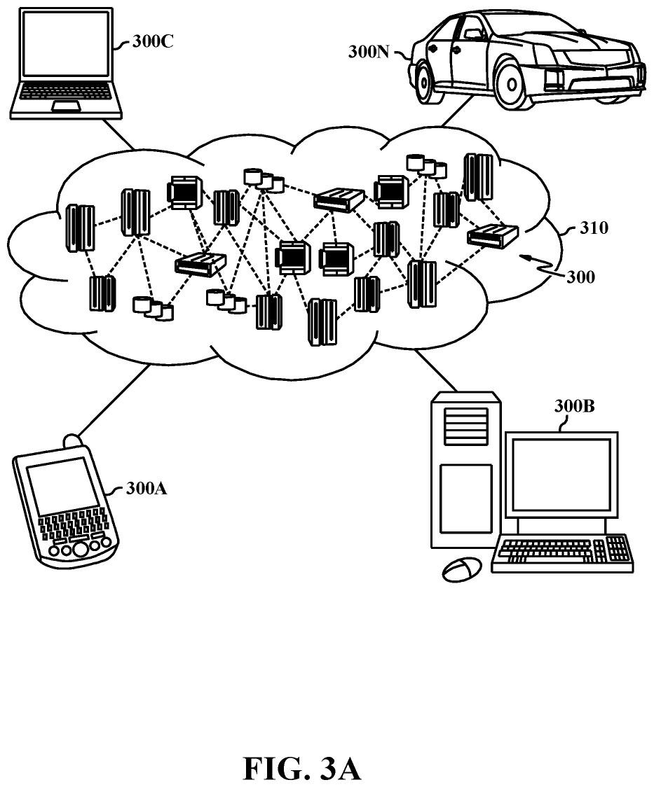

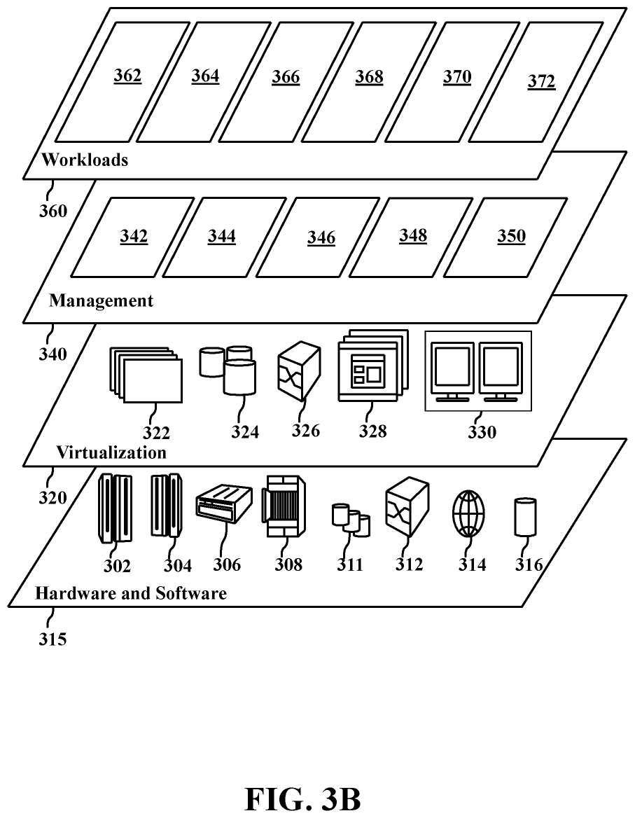

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and determining an instability/disequilibrium state of an object 372.

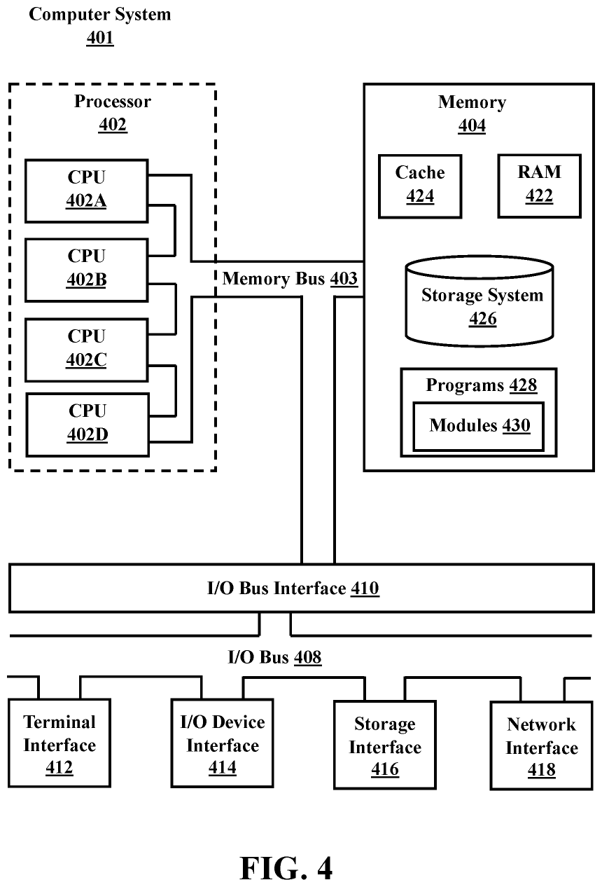

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, object data associated with a position and an orientation of a first object in an environment from internet of things (IoT) sensors;
generating a digital twin simulation of the first object, wherein the digital twin simulation includes data associated with relative positions and orientations of one or more other objects to the first object;
calculating forces acting on the first object; and
identifying whether the first object is in a state of instability.

2. The computer-implemented method of claim 1, further comprising:
receiving second object data associated with a position and an orientation of a second object in an environment from the IoT sensors;
generating a second digital twin simulation based on the second object, wherein the second digital twin simulation includes data associated with relative positions and orientations of one or more other objects to the second object;
calculating forces acting on the second object; and
ranking an instability score associated with the first object relative to an instability score associated with the second object.

3. The computer-implemented method of claim 1, further comprising:
predicting a likelihood of an incident associated with the state of instability of the first object.

4. The computer-implemented method of claim 1, further comprising:
recommending an alternative position or an alternative orientation of the first object using an augmented reality interface.

5. The computer-implemented method of claim 4, further comprising:
identifying the alternative position or the alternative orientation of the first object;
generating an alternative digital twin simulation of the first object, wherein the digital twin simulation includes data associated with the relative positions and orientations of one or more other objects to the first object having the alternative position or the alternative orientation; and
calculating forces acting on the first object having the alternative position or the alternative orientation, wherein the forces do not result in a state of instability for the first object.

6. The computer-implemented method of claim 1, further comprising:
monitoring a position of a user within the environment;
predicting one or more future positions of the user within the environment; and
predicting a change to the state of instability of the first object based on the one or more future positions of the user.

7. The computer-implemented method of claim 6, further comprising:
identifying one or more alternative positions of the user;
generating an alternative digital twin simulation based on the one or more alternative positions of the user, wherein the alternative digital twin simulation includes data associated with the one or more alternative positions of the user relative to the first object; and
calculating alternative forces acting on the first object, wherein the alternative forces do not result in a state of instability for the first object.

8. A system comprising:
a memory; and
a processor in communication with the memory, the processor being configured to perform operations comprising:
receiving object data associated with a position and an orientation of a first object in an environment from internet of things (IoT) sensors;
generating a digital twin simulation of the first object, wherein the digital twin simulation includes data associated with relative positions and orientations of one or more other objects to the first object;
calculating forces acting on the first object; and
identifying whether the first object is in a state of instability.

9. The system of claim 8, the processor being further configured to perform operations comprising:
receiving second object data associated with a position and an orientation of a second object in an environment from the IoT sensors;
generating a second digital twin simulation based on the second object, wherein the digital twin simulation includes data associated with relative positions and orientations of one or more other objects to the second object;
calculating forces acting on the second object; and
ranking an instability score associated with the first object relative to an instability score associated with the second object.

10. The system of claim 8, the processor being further configured to perform operations comprising: predicting a likelihood of an incident associated with the state of instability of the first object.

11. The system of claim 8, the processor being further configured to perform operations comprising: recommending an alternative position or an alternative orientation of the first object using an augmented reality interface.

12. The system of claim 11, the processor being further configured to perform operations comprising:
identifying the alternative position or the alternative orientation of the first object;
generating an alternative digital twin simulation of the first object, wherein the digital twin simulation includes data associated with the relative positions and orientations of one or more other objects to the first object having the alternative position or the alternative orientation; and
calculating forces acting on the first object having the alternative position or the alternative orientation, wherein the forces do not result in a state of instability for the first object.

13. The system of claim 8, the processor being further configured to perform operations comprising:
monitoring a position of a user within the environment;
predicting one or more future positions of the user within the environment; and
predicting a change to the state of instability of the first object based on the one or more future positions of the user.

14. The system of claim 13, the processor being further configured to perform operations comprising:
identifying one or more alternative positions of the user;
generating an alternative digital twin simulation based on the one or more alternative positions of the user, wherein the alternative digital twin simulation includes data associated with the one or more alternative positions of the user relative to the first object; and
calculating alternative forces acting on the first object, wherein the alternative forces do not result in a state of instability for the first object.

15. A computer program product comprising a computer readable storage medium having program instructions embodied therewith, the program instructions executable by a processor to cause the processor to perform operations, the operations comprising:
receiving object data associated with a position and an orientation of a first object in an environment from internet of things (IoT) sensors;
generating a digital twin simulation of the first object, wherein the digital twin simulation includes data associated with relative positions and orientations of one or more other objects to the first object;
calculating forces acting on the first object; and
identifying whether the first object is in a state of instability.

16. The computer program product of claim 15, the processor being further configured to perform operations comprising:
receiving second object data associated with a position and an orientation of a second object in an environment from the IoT sensors;
generating a second digital twin simulation based on the second object, wherein the second digital twin simulation includes data associated with relative positions and orientations of one or more other objects to the second object;
calculating forces acting on the second object; and
ranking an instability score associated with the first object relative to an instability score associated with the second object.

17. The computer program product of claim 15, the processor being further configured to perform operations comprising: predicting a likelihood of an incident associated with the state of instability of the first object.

18. The computer program product of claim 15, the processor being further configured to perform operations comprising: recommending an alternative position or an alternative orientation of the first object using an augmented reality interface.

19. The computer program product of claim 15, the processor being further configured to perform operations comprising:
monitoring a position of a user within the environment;
predicting one or more future positions of the user within the environment; and
predicting a change to the state of instability of the first object based on the one or more future positions of the user.

20. The computer program product of claim 15, the processor being further configured to perform operations comprising:
identifying one or more alternative positions of the user;
generating an alternative digital twin simulation based on the one or more alternative positions of the user, wherein the alternative digital twin simulation includes data associated with the one or more alternative positions of the user relative to the first object; and
calculating alternative forces acting on the first object, wherein the alternative forces do not result in a state of instability for the first object.
